(19) United States
(12) Patent Application Publication
(10) Pub. No.: US 2004/0124554 A1
(43) Pub. Date: Jul. 1, 2004

(54) Polyolefin isolation membrane

(75) Inventors: Jeff Lippy, Front Royal, VA (US); Glenn Owens, Front Royal, VA (US); Andrew Aitken, Front Royal, VA (US); Alan Franc, Front Royal, VA (US)

Correspondence Address: Wayne C. Jaeschke, Jr., Morrison & Foerster LLP, Suite 300, 1650 Tysons Boulevard, McLean, VA, 22102, US

(73) Assignee: Toray Plastics (America), Inc., Front Royal, VA

(21) Appl. No.: 10/665,370

(22) Filed: Sep. 22, 2003

Related U.S. Application Data
(60) Provisional application No. 60/412,561, filed on Sep. 23, 2002.

(51) Int. Cl. C08J 9/00

(52) U.S. Cl. 264/50; 521/50

(57) ABSTRACT

This invention relates to an isolation gasket intended to reduce the damage and wear of finishing layers, such as ceramic tiles, when installed over a rigid support layer, such as concrete. The disclosed isolation gasket prevents the propagation of cracks that may develop in the supporting layer through to the finishing layer. A preferred isolation gasket is a low-density, crosslinked polyolefin foam having a density of from about 60 kg/m3 to about 200 kg/m3, a compressive strength of from about ⅕ kg/cm2 to about 8 kg/cm2, a shear strength of at least 2 mm, and a thickness of at least 0.5 mm.

### FIELD OF THE INVENTION

The invention relates to a membrane for use as an isolating layer between a supporting substrate and a finishing layer. Typically, the supporting substrate may be a sub-floor layer such as concrete and the finishing layer may include ceramic tile, or other such materials prone to excessive wear and damage that occurs when cracks and other defects in the supporting layer propagate to the finishing layer. The preferred isolation layer is a crosslinked polyolefin membrane.

### BACKGROUND OF THE INVENTION

The present invention relates generally to a system for inhibiting or limiting the transfer and propagation of cracks from foundational materials or substrates, such as sub flooring, to finish layers disposed thereon, such as tile, stone and other relatively brittle materials. In particular, the invention relates to an innovative system incorporating a composite material disposed between the substrate and the finish layers to absorb or dissipate movement in the substrate due, for example, to cracking, fissuring and the like. A number of surface finishing techniques are known for covering floors, walls, counters and the like. One such technique involves securing tile, stone panels or sheets and the like to the support surface or substrate via a cement or glue. In the case of flooring, such surface finishing materials are generally cemented to a sub floor or foundation layer such as concrete. The sub floor may be a slab disposed directly on the ground, or may consist of a single or multiple sections supported on a superstructure creating elevated floor levels, such as in a multistory structure.

Where tiles, stone and similar materials are applied to concrete and similar substrates, a problem exists when the substrate undergoes movement, cracks or fissures beneath the overlying material. This problem is exacerbated by the generally brittle nature of many finishing materials, such as tiles and stone. Where such materials are cemented or glued directly to the substrate, cracks in the underlying layers tend to be transmitted to the finishing materials, resulting visible cracks. In the case of sectional finishing materials, such as ceramic tile, such cracks may occur both between tiles and through individual tiles. Over time, such cracking can substantially mar the appearance of the finished surface and deteriorate the surface, particularly surrounding the broken or fractured areas.

Techniques have been developed in an attempt to prevent, or at least to inhibit, the propagation of cracks from a structural substrate to an overlying finishing material. In one such technique, a non-woven fabric sheet is laid over and secured to the substrate and the finishing material is secured to the fabric. Previously, various methods were set forth for reducing or eliminating wear or damage to finishing layers, such as ceramic tiling, that resulted from the propagation of cracks in the supporting layer, which is usually concrete. For example U.S. Pat. No. 5,255,482, to Whiteacre, U.S. Pat. No. 6,094,878, to Schluter, and U.S. Pat. No. 4,567,704, to Bernett, each disclose various approaches to this problem. Each of these references is hereby incorporated by reference in its entirety.

Primarily, prior art techniques require that a polymer membrane layer is disposed over the substrate and the finishing material secured to the membrane. A serious drawback of previously known techniques is the relatively high cost of the intermediate sheet or membrane, which significantly increases the cost of the overall finishing operation. Moreover, certain formulations of the intermediate sheets or membranes do not provide the resiliency desirable for suppression or inhibition of crack transmission to the finishing material.

Other, generally similar, techniques have been proposed for interposing various materials between a sub floor and a finishing material, such as tile or stone, to absorb or dissipate sound. In one such technique, a relatively thick layer of composition cork, typically 6 millimeters thick, is interposed between the substrate and the finishing material. The material aids in deadening sound through the flooring, but typically only provides limited capability for suppressing crack transmission between the sub floor and finishing layer. Moreover, like the non-woven and polymer membrane materials, the composition cork material can add unnecessarily to the cost of the finishing operation, particularly where sound deadening is less an issue than crack inhibition.

There is a need, therefore, for an improved technique for isolating a finishing layer, such as a relatively brittle floor covering, from a structural substrate so as to prevent or inhibit transmission of cracks and fissures from the substrate to the finishing layer. In particular, there is a need for such a technique that makes use of an isolation material that is less expensive than known materials, but that is sufficiently resilient to isolate the substrate from the finishing layer. In addition, the technique should be relatively easy and rapid, so as to permit the finishing operation to be carried out in a timely manner by artisans already familiar with the basic finishing technique. Conventional anti-fracture membranes are typically high-density materials such as plasticized PVC (polyvinylchloride), acrylics, silicones, urethanes chlorinated polyethylene, or laminations of layers differing materials, some of which are corrugated, or formed into shapes to achieve the compressive strength and shear requirements.

One disadvantage of these conventional solid membranes is the relatively heavy weight of the membrane when compared to cellular constructions, such as foam. The density of solid membranes may range from 9000˜1500 kg/m3. Compared to cellular materials, the increased material per square foot of membrane correlates to increased cost. There is a need for lower cost, lighter weight materials with the physical properties necessary to meet the functional requirements of an isolation membrane. Foams with densities that range from 30kg/m3 to 200 kg/m3 offer significantly reduced material usage, and therefore cost benefits, when compared to solid isolation membranes.

Lighter weight isolation membranes are easier to handle and install. Rolls of solid isolation membranes are heavy and can be more difficult to handle and install. Use of conventional lower density materials such as extruded polystyrene or non-crosslinked polyethylene foam, as an isolation membrane, has not yet been possible, since these conventional foams do not have the necessary mechanical properties, such as shear strength, or compressive strength, to meet the functional requirements of an isolation membrane.

### SUMMARY OF THE INVENTION

A method (system) is provided for inhibiting or suppressing the transmission and propagation of cracks between a supporting substrate and a finishing layer. The system is applicable for floorings, walls, counters and other surfaces where a relatively fragile finishing surface, such as tile, marble or natural stone disposed on a base material, such as concrete. The system includes a first adhesive layer disposed on the substrate, an isolating layer of a crosslinked foam material disposed on the first adhesive layer, a second adhesive layer disposed over the isolating layer, and the finishing layer applied over the second adhesive layer.

The isolating layer is most preferably a polyolefin material approximately 1.0 millimeter in thickness, approximately 100 kg/m3 density, and approximately 40% crosslinked as measured by Toray Method, as described in Example 1. The system inhibits or suppresses the transmission and propagation of cracks, fissures and the like that may develop over time from the substrate layer to the finishing layer.

### BRIEF DESCRIPTION OF THE DRAWINGS

FIG. 1 illustrates an embodiment of the present invention where the isolation layer is used to inhibit the propagation of a crack from a concrete support structure to a ceramic tile finishing layer.

FIG. 2 illustrates the shear strength test, according to the disclosed method.

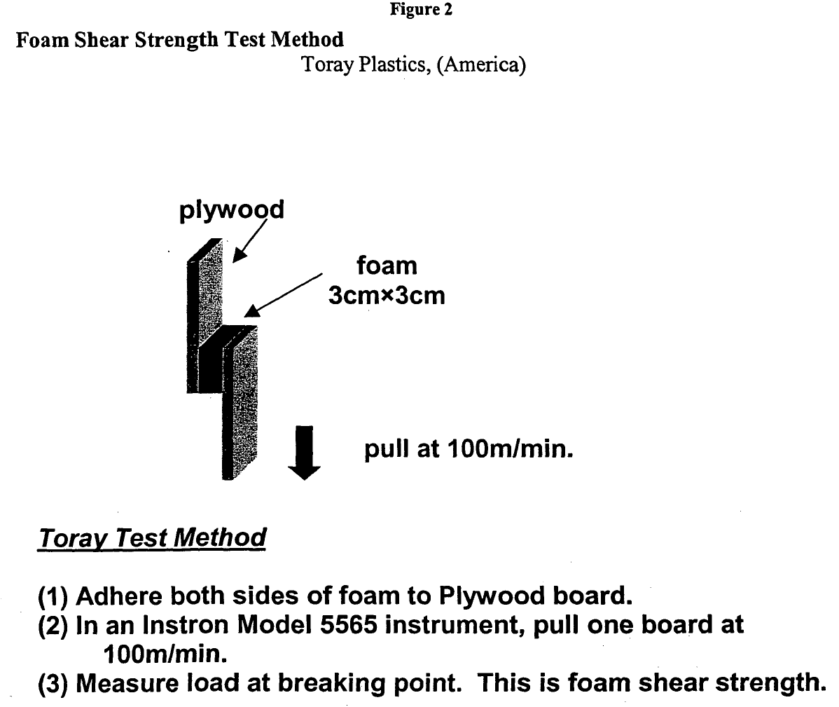

FIG. 3 illustrates compressive strength correlated against foam density.

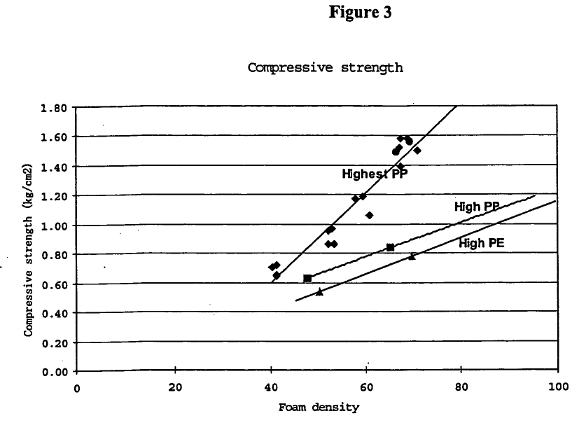

### DETAILED DESCRIPTION OF THE INVENTION

An illustrative isolation material and method of manufacture, therefor, are as follows. The first step is the mixing of polyolefin resins (such as any type of polyethylene, or polypropylene), foaming agent, with or without crosslinking agents, and with or without other additives into a homogenous mixture. The homogenous mixture is achieved by spinning in a mechanical mixer designed for compounding plastic resins. The process is conventional and is familiar to a person with basic knowledge of plastics processing. The rate of agitation, temperature, and duration of processing is carefully controlled during this step.

The second step is the conversion of the ingredients into a solid, thin, web. Mixing the ingredients in a conventional plastics extruder, in which the ingredients are conveyed in a barrel by a screw, produces the solid plastic web. The ingredients are initially compressed and mixed as the materials move along the screw. Heater elements, along with the shearing action of materials against each other and the screw and barrel, cause the resins to melt into a viscous liquid state. The screw pushes the melted extrudate through a die opening to produce the thin, solid web. The web may typically be between 0.2 and 3.0 mm in thickness at this point, although there is no reason why thicker or thinner webs could not be produced. The web is cooled, trimmed, and wound into a roll. The third step is to crosslink the polymer resins together. Irradiation of the polyolefin plastic is done by electron beam, however, other methods, including chemical crosslinking may also be performed. The degree of crosslinking may be controlled to result in a typical crosslink density of 0˜75%, although there is no reason why higher percentage level of crosslinking could not be obtained. Further, higher levels of crosslinking would not have an adverse effect on the performance of an isolation layer made therefrom.

The fourth step is to convert the continuous polymer web into low-density foam. Typically the foam is heated by irradiated heaters, salt, hot air, or other heating devices. Heat reacts a chemical foaming agent that releases gases, forming the cellular structure in the web. The combination of resins selected, crosslinking, and the process used can create a fine-celled structure with cells ranging from 0.2˜1.0 mm, although greater or smaller cell size is possible. The finished foam web is rolled onto a core.

The finished foam web typically undergoes further processing, in which it may be coated with an adhesive layer or release layer, or laminated, or often molded for a variety of uses, such as automotive instrument panels, gaskets, packaging, etc.

The isolation layer, or membrane, is a mixture of ethylene propylene copolymer (EPC) and linear low density polyethylene (LLDPE). The copolymer content is preferably in the range of about 50˜90%, by weight. The preferred range of EPC content is about 20˜100%, by weight. It is desirable to maintain the amount of EPC in this range, to achieve the preferred compressive strength, although other olefin materials can also be used. Other materials that will also work and are therefore preferred are other olefin materials such as homopolymers and copolymers of Polyethylene including HDPE, LDPE VLDPE, ULDPE, and polymers or copolymers of Polypropylenes, including EPC ethylene propylene copolymer.

The preferred thickness of the foam isolation membrane is between 0.5 and 3.0 mm, while the most preferable thickness is 0.8 to 1.2 mm. There is no reason why foams between 0.2 and 12 mm could not be used. However, foams less than the preferred minimum may lack the resiliency under the forces of cracking to prevent membrane rupture and crack propagation. Foams thicker than the preferred maximum thickness of 3.0 mm are also suitable as crack isolation membranes, however relatively thick layers of 6 mm or more may begin to interfere with wall molding or door clearances. Thickness is determined by the resin selection, type and amount of chemical foaming agent used, extruded sheet thickness, tension during the foaming operation, amount of heat applied during the conversion of sheet into foam. For example, a I.Omm extruded sheet may produce a relatively high-density 1.5 mm Polyethylene foam if little foaming agent is used, or a relatively low-density, 2.5 mm foam may be produced if a greater quantity of foaming agent is used.

The most preferred density of this foam ranges from 100 to 125 kg/m3 by method ASTM D3575W. The preferred range is 60 to 200 kg/m3. If the density of the foam is less than 60 kg/m3, the isolating membrane may be too soft and compress under loading, which is undesirable. There is no reason why higher than 200 kg/m3 would not work, however higher density materials are less economically attractive, and higher density materials may require modifiers to increase resiliency. Density is achieved by a number of factors, the selection of resins used, the degree of crosslinking, process conditions, and the type and amount of foaming agent used.

The preferred range for polymer cross-linking between 20% and 65% by weight (Toray Method of Example 1), and the most preferred range is approximately 40% cross-linking. The crosslinking percentage should be within this range, because if crosslinking is too high the foam will be difficult to roll onto a core and would be difficult to lay flat. If crosslinking is less than the preferred range, it may still perform adequately as an isolation membrane, but the foam will be difficult to process and shear strength and other physical properties will be less than desirable. The degree of crosslinking is determined by the type of resins selected, the amount of chemical crosslinking agent used, the exposure to a radiation source such as an electron beam.

Compressive strength (by ASTM D3575) is for the construction is approximately 6 kg/cm2. The most preferred range for compressive strength property is between 1.5 kg/cm2 to 8 kg/cm2, although there is no reason why higher compressive strengths would not work. Compressive strength needs to be above the minimum of 1.5 kg/m3, as materials below this range may be too soft and compress under a heavy load, and result in tile cracking.

High compression strength is needed so when a heavy object, such as a refrigerator, is moved across the tile, the foam doesn't compress too much under the tile and cause it to crack. The test used to measure this durability performance is called the Robinson test.

Compressive strength is a property of the foam structure obtained primarily by the selection of resin, foam density, and the manufacturing processes used to convert resin into foam. Higher polypropylene content yields greater compressive strength. Density is also a key factor. For example, to increase compressive strength from approximately 3 kg/cm2 to approximately 6 kg/cm2, the foam density was increased by from 100 kg/m3 to 121 kg/m3.

Shear strength/strain (Toray method) in the horizontal plane is preferably approximately 3 mm or better prior to foam rupture. The most preferable range for shear strain is 2˜5 mm, although greater strain should only further isolate the tile surface from cracking. If shear strain is less than 1 mm at rupture, the foam may break and allow cracks to propagate from the substrate.

This property is indicative of the isolating membrane's ability to move as the flooring substrate shifts, settles, or cracks over time, yet isolate the tile or other finishing medium above from the movement. Shear/Shear strain is determined by the Toray method. Example 1 describes the Toray Method for shear testing:

### EXAMPLE 1

### Foam Shear Strength Test Method

Cut two pieces of wood paneling 4×4 inches for each foam sample

Prepare foam samples per WI-0007

Use adhesive mixture within four hours of preparation

The MD direction of the foam aligns with the grain of the wood

Measure 3 cm down from the top edge and mark a line across the width of the wood

Use tape to cover the wood below the line to protect it from the adhesive.

Corona treat one side of the foam sample

Preheat an oven to 140° C.

Prepare Adhesive

In a plastic beaker mix 100 parts Bostik 7662S with 10 parts Boscodor 2E. Use a glass stir and plastic siphon if needed.

Boscodor 2E keep bottle flat. Do not let the liquid touch the cap

When finished replace the air in the bottle with Nitrogen and cap securely

Using a #74 coating bar apply an even coat of adhesive to the wood panels covering the 3×3 cm area

Apply adhesive to the corona treat side of the foam. Put the coating bar back in the container when not in use

Wait 30 minutes for the adhesive to setup

Put one prepared foam and one prepared panel samples (remove tape) on a plate and place in the oven for 60 seconds

Remove from the oven and very quickly press the foam sample to the wood sample. It helps to use another panel or plate to apply uniform pressure. Trim excess foam away from panel

On the above sample corona treat the other side of the foam and apply adhesive

Prepare the other wood panel with adhesive and label H & Q side of foam on panels

Wait 30 minutes and repeat oven procedure

### EXAMPLE 2

### Method of Manufacture of Crosslinked Polyolefin Isolation Gasket

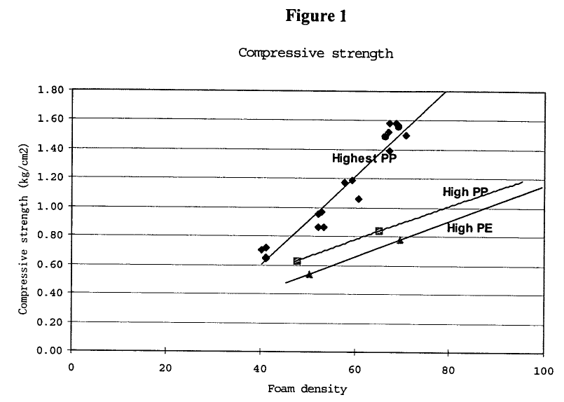

Drawing FIG. 1 illustrates a preferred floor construction using the crosslinked polyolefin isolation gasket. Methods for setting of ceramic tile are described in standards of ANSI 108.1A, A108.aB, A108.1C, or in the Handbookfor Ceramic Tile Installation Volume 40. First, the substrate material layer I is a concrete slab, which can be laid on the ground or supporting structures of elevated stories in a multi-story building. The method for laying concrete uses conventional techniques familiar to a person who installs concrete slabs. More generally, the substrate material layer 1 could consist of a number of materials, including varieties of concrete, stone, or any other materials that may pose a risk of fracture or cracking over time. The concrete slab layer 1 is well cured, free of cracks, and cleaned of any oils, water, dust or debris in preparation for the application of the adhesive layer 2. Any cracks in the concrete slab should be filled with high-grade epoxy filler. Once the slab layer 1 is prepared, the adhesive layer 2 is applied to layer 1 by methods specified in ANSI or the TCA Handbook. The adhesive preferably consists of a high-grade Type 1 organic adhesive conforming to ANSI A118.4, or a Thin-set or latex-Portland cement mortar conforming to ANSI 108.5. The cross-linked polyolefin foam isolation membrane, layer 3, is laid over the adhesive layer 2 and trimmed to make flush joints with no gaps between adjacent sheets of the isolation membrane, making a uniform layer covering the entire surface of layer 2. Depending on the adhesive type used for layer 2, a 50 lb roller may be used to remove air pockets and ensure intimate contact and adhesion between adhesive layer 2 and the isolation lyaer 3. Adhesive layer 4 is preferably a Thin-set, latex-modified Portland cement mortar applied with a trowel or spatula using techniques familiar to a person with expertise in this installation. Adhesive layer 4 is preferably about 3 mm thick. The finishing layer 5 are ceramic tiles which are laid over adhesive layer 4 in an evenly spaced pattern. Layer 6 is a grout material, applied between the tiles. Adhesive layers 2,4, and 6 are allowed to dry.

### EXAMPLE 3

### Determining the Percent of Polymer Crosslinking Achieved by the Irradiation Process

Apparatus Needed:

100 mesh, 0.004″ wire diameter, Type 304, stainless steel baggies

Numbered wires & clips

Miyamoto Thermostatic oil bath apparatus

Analytical balance

Fume hood

Gas burner

High temperature oven

Anti-static gun

Three 3.5 liter wide mouth stainless steel containers with lids

Reagents and Materials Needed:

Solvent X, Laboratory grade

Acetone

Silicone oil

Preparation of Test Sample.

Weigh an empty wire mesh bag and record weight.

Weigh out X mg+/−5 mg of sample and transfer it to the wire mesh bag, where X may vary.

Record weight of wire mesh bag+foam cuttings in Gel Fraction log.

Each bag is attached to the corresponding number wire & clips.

Dissolving of Non-Crosslinked Foam.

When Solvent X temperature reaches XC, immerse the bundle in the Solvent X

Shake the samples up and down 5 or 6 times to loosen air bubbles and fully wet samples.

Attach samples to agitator and agitate for X hours at XC.

After x hours, shut off oil bath apparatus.

Cool samples in fume hood.

Sample Washing.

Wash samples by shaking up and down 7 or 8 times in a container of primary wash Acetone.

Wash samples in the same manner in the secondary wash Acetone.

Wash samples once more in 3rd container fresh Acetone as above.

Hang samples in fume hood to evaporate acetone, 1-5 mins.

Sample drying and cooling

Dry the samples in the XC drying oven for 1 hour.

Cool the samples for a minimum of 15 minutes.

Weigh the wire mesh bag on the analytical balance and record.

Calculation of % Gel Fraction:

A=empty wire mesh bag weight

B=wire bag wt+foam sample before immersion in solvent x

C=wire bag wt+dissolved sample after immersion in solvent x

$$\% Gel Fraction = \frac{C - A}{B - A} \times 100$$

We claim:

1. An isolation gasket material comprising a crosslinked polyolefin foam having a density of from about 60 kg/m3 to about 200 kg/m3, a compressive strength of from about ⅕ kg/cm2 to about 8 kg/cm2, a shear strength of at least 2 mm, and a thickness of at least 0.5 mm.

2. The isolation gasket of claim 1 wherein the crosslinked polyolefin foam is comprised of ethylene propylene copolymer and linear low density polyethlyene.

3. The isolation gasket of claim 2 wherein the ethylene propylene copolymer content is from about 50% to about 90%, by weight.

4. The isolation gasket of claim 2 wherein the ethylene propylene copolymer content is at least 20%, by weight.

5. The isolation gasket of claim 1 having a thickness of from about 0.8 mm to about 1.2 mm.

6. The isolation gasket of claim 1 having a fine cell structure with cells ranging from about 0.2 mm to about 1.0 mm.

7. The isolation gasket of claim 1 having a density of from about 100 kg/m3 to about 125 kg/m3.

8. The isolation gasket of claim 1 having a compressive strength of about 6 kg/cm2.

9. The isolation gasket of claim 1 having a shear strength of at least 3 mm.

10. The isolation gasket of claim 2 having a degree of polymer crosslinking of from about 20%, by weight, to about 65%, by weight.

11. The isolation gasket of claim 10 having about 40%, by weight, polymer crosslinking.

12. A method of manufacturing a crosslinked polyolefin isolation gasket comprising:
mixing a resin mixture comprising polyolefin resins into a homogeneous mixture;
extruding the homogeneous mixture into a web having a thickness of from about 0.2 to about 3 mm;
cooling the web;
crosslinking the polymers in the web together to form a continuous polymer web;
heating the continuous polymer web to form a low-density, crosslinked polyolefin foam.

13. The method of claim 12, wherein the resin mixture further comprises foaming agents and/or crosslinking agents.

14. The method claim 12 wherein the continuous polymer web has a degree of crosslinking of less than about 75%.

15. An isolation gasket material made in accordance with claim 14.
